(19) United States
(12) Patent Application Publication
(10) Pub. No.: US 2017/0268674 A1
(43) Pub. Date: Sep. 21, 2017

(54) METHOD OF MANUFACTURING AN ANNULAR SEAL

(71) Applicant: Aktiebolaget SKF, Goteborg (SE)

(72) Inventors: Stellario Barbera, Hilversum (NL); Roberto Daghero, Nieuwegein (NL)

(21) Appl. No.: 15/532,154

(22) PCT Filed: Dec. 2, 2015
(86) PCT No.: PCT/EP2015/078293

§ 371 Date: Jun. 1, 2017

(30) Foreign Application Priority Data
Dec. 8, 2014 (GB) 1421768.1

(51) Int. Cl. F16J 15/10; F16J 15/328

(52) U.S. Cl. CPC F16J 15/108; F16J 15/328

(57) ABSTRACT

A method of manufacturing an annular seal includes: providing an intermediate having an annular layer of an elastomeric first material bonded to an annular layer of a second material, the second material different from the first material; and machining the intermediate to form the annular seal having the first and second materials. The intermediate machined to provide a U-shaped profile and is defined by a radially extending wall, an outer flange wall extending axially from the radial wall, and an inner flange wall facing the outer flange wall and extending axially from the radial wall. The annular seal has a seal lip that extends radially inward from the inner flange wall and is formed from the second material. The second material has one or more of: a lower coefficient of friction, a higher heat resistance, a higher wear resistance and/or a higher chemical resistance than the first material.

### FIELD OF THE INVENTION

The present invention relates to the field of annular seals, for sealing an annular gap between relatively rotatable components, and their manufacture.

### BACKGROUND OF THE INVENTION

Seals are used to prevent leakage between two environments. Seals can be used, for example, to retain a fluid, separate fluids or to prevent the transmission of particulate contaminants from one environment to another. A static seal would completely prevent leakage if the contacting surfaces were perfectly smooth or if the asperities in contact are heavily deformed and sufficiently flattened.

Seals can also be used in non-static devices such as rolling element bearings. Non-static devices rely on seals to retain lubricant, prevent water ingress and to prevent particulate contamination, such as grit, of the easily damaged rolling element. They also rely on an extremely thin elasto-hydrodynamic film between the seal and the moving surface to prevent excessive wear of the seal, particularly on start-up when slow movement leads to large frictional forces and the seal is most prone to wear.

Bearing seals are typically formed of a rubber component having a suitable shape. In some cases a lubricating coating and/or low friction coating is applied to the suitably-shaped rubber component in order to reduce friction between the seal and, for example, a shaft extending through the bearing. It is also known to attach a rigid component to the suitably-shaped rubber component in order to provide a bearing seal with suitable rigidity. Such components are difficult to manufacture.

Seals may be manufactured by machining the end face of a tubular rubber billet into a desired seal profile and then slicing the machined billet to form the seal. Such machining may be carried out, for example, using an SKF SEALJET machine. If the seal is required to have additional components, for example a low friction coating or a rigid component, then these must be attached or applied after machining. Accordingly, the complexity of the manufacturing method is increased.

It is an objective of the present invention to address or at least mitigate some of the problems associated with the prior art or to provide a commercially acceptable alternative thereto. In particular, embodiments of the invention can provide a more easily manufactured seal, for example, a bearing seal.

### BRIEF SUMMARY OF THE INVENTION

In a first aspect, the present invention provides a method of manufacturing an annular seal, the method comprising the steps of:

(i) providing an intermediate having an annular layer of an elastomeric first material bonded to an annular layer of a second material, the second material being different from the first material; and

(ii) machining the intermediate to form an annular seal comprising the first and second materials.

According to the invention, the intermediate is machined to provide a profile that is generally U-shaped and is defined by a radially extending wall, an outer flange wall extending axially from the radial wall, and an inner flange wall facing the outer flange wall and extending axially from the radial wall. Furthermore, the annular seal has a seal lip that extends radially inward from the inner flange wall, whereby the seal lip is formed from the second material and the second material has one or more of: a lower coefficient of friction, a higher heat resistance, a higher wear resistance and/or a higher chemical resistance that the first material.

The method according to the present invention enables the manufacture of a seal by joining annular layers of first and second materials prior to the step of machining. Advantageously, it is not then necessary to provide further material parts of the seal that must accurately conform to the shape of the first material.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### BRIEF DESCRIPTION OF THE SEVERAL VIEWS OF THE DRAWING

For a better understanding of the invention and to show how the same may be put into effect, reference is now made, by way of example only, to the accompanying drawings in which:

FIG. 1 shows an intermediate for use in manufacturing a seal according to a first embodiment of the method of the invention;

FIG. 2 shows a cross-section of a seal manufactured from the intermediate of FIG. 1;

FIG. 3 shows an intermediate for use in manufacturing a seal according to a second embodiment of the method of the invention; and

FIG. 4 shows a cross-section of a seal manufactured from the intermediate of FIG. 3.

### DETAILED DESCRIPTION OF THE INVENTION

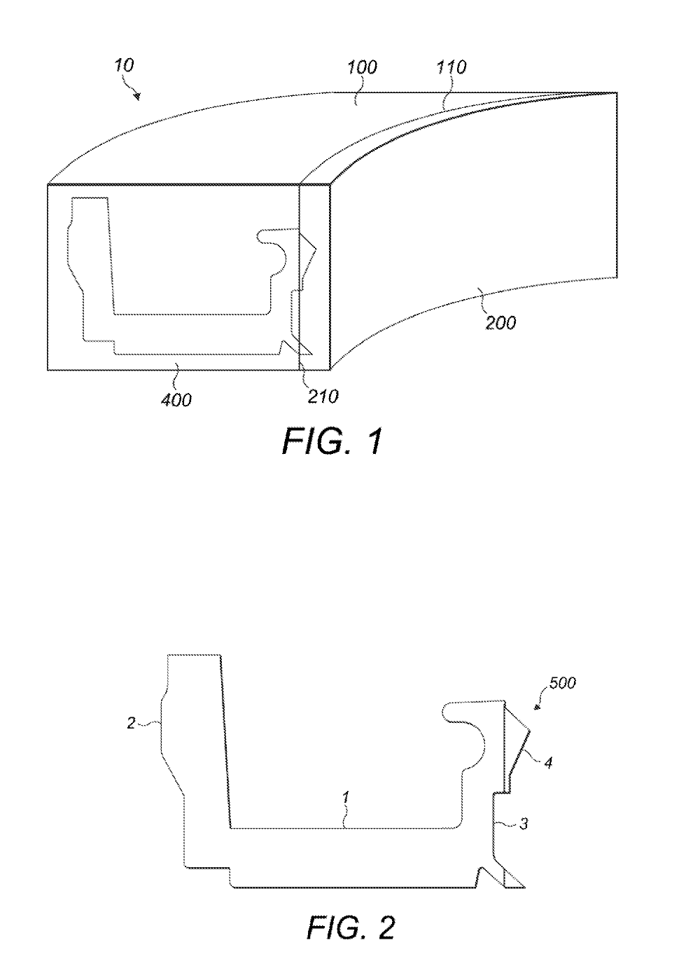

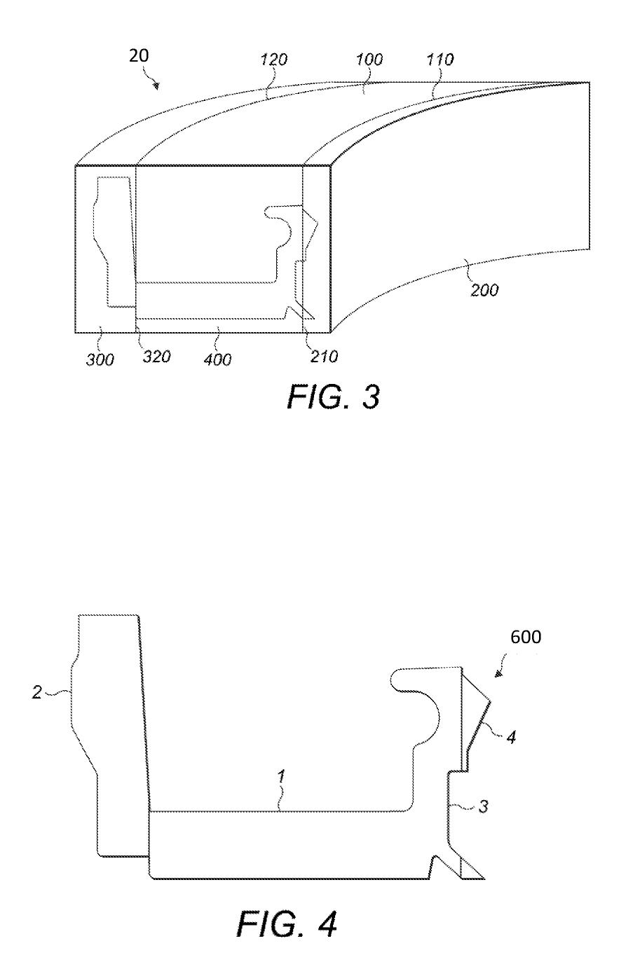

With reference to FIGS. 1 and 3, a first embodiment of a method of manufacturing a seal 500 in accordance with the invention comprises the steps of providing a first material 100 and bonding a second material 200 to the first material 100 to form an intermediate 10. The second material 200 is a different material from the first material 100 and, advantageously, can be chosen to provide different material properties. The first and second materials 100, 200 are provided as annular layers, such that the intermediate 10 is also of annular shape.

The first material 100 may be an elastomeric material such as one from which seals are typically manufactured. The elastomeric first material may comprise, for example, one or more of fluoroelastomer (FKM), perfluoroelastomer (FFKM), nitrile butadiene rubber (NBR), hydrogenated nitrile butadiene rubber (HNBR), carboxylated nitrile butadiene rubber (XNBR), silicone (VMQ), polyurethane (PU), neoprene (chloroprene), ethylene-propylene-diene (EPDM), ethylene-propylene (EPM), styrene-butadiene (SBR), isobutene-isoprene, thermoplastic polyurethane (TPU) and thermoplastic elastomers (TPE).

The combination of the elastomeric first material 100 and the second material 200 may be customized for specific applications in order to achieve superior performances compared with seals comprising only one of these materials. Such a combination could also be chosen in order to obtain higher performances at lower cost, using more expensive materials in reduced quantity.

In this first embodiment, the second material 200 may exhibit one or more of: a lower coefficient of friction, a higher heat resistance, a higher wear resistance and/or a higher chemical resistance than the first material. Such properties may be advantageously exhibited by a material forming a sealing surface of the seal such as, for example, the surface of a seal lip. It may be advantageous that a low coefficient of friction, high heat resistance, high wear resistance and/or a high chemical resistance is provided by the second material 200, rather than necessarily by the entire intermediate 10. This is because materials that provide such properties may exhibit other properties that are not favourable in the resulting seal, for example low elasticity.

The second material 200 may comprise a polymer, for example, one or more of the materials specified above for the elastomeric first material, and optionally a filler. The filler is typically dispersed within the polymer, i.e. the polymer is the continuous phase and the filler is the discontinuous phase. The filler may be a friction modifier. The friction modifier may be any substance that, in use, can reduce the sliding friction of the material against the counterface. Preferred friction modifiers include, for example, graphite, PTFE, MoS2, nano-fillers, fullerene-like fillers and waxes. The incorporation of a friction modifier into the polymer may lower friction losses by up to 60% and may increase the lifetime of the seal. Depending on the particular combination of the polymer and friction modifier, the friction coefficient may be lowered down to 0.05 from an average of 0.35. In order to reduce friction, the second material 200 may be formulated so as to increase the film thickness of the lubricant to be retained. For example, a material swollen with lubricant has a lower friction coefficient because it releases lubricant under pressure and thus supplies lubricant to the contact surfaces. The polymer and filler combination may also be selected so that the second material 200 exhibits a higher heat resistance, a higher wear resistance and/or a higher chemical resistance than the first material 100.

It is also envisaged that the second material 200 may simply comprise or consist of a coating of a low friction material such as, for example, graphite, PTFE and/or MoS2.

In this first embodiment, the second material 200 may exhibit a greater stiffness than the first material 100. This may serve to maintain the shape of the seal 500 in use. The second material 200 may comprise a polymer and a filler. The filler is typically dispersed in the polymer. The polymer and filler combination may be chosen to provide the second material 200 with a higher hardness and/or higher elastic modulus in comparison to the first material 100. This may help the resultant seal to be retained in a bore, in use. The polymer and filler combination may be chosen to increase the tackiness of a surface of the resultant seal 500 and also help maintain the structure of the resultant seal 500. The polymer and filler combination may be chosen to ensure that the properties of the second material 200 are maintained for a long period of time under typical working conditions of the resultant seal 500, thereby increasing the lifetime of the seal 500.

The first material 100 is preferably provided in the shape of an annulus or tube, having a bore with an internal surface 110. The second material 200 may be provided as an annulus or tube, having an outer surface 210. Preferably, the first material 100 has a smooth surface, the second material 200 has a complementary smooth surface, and these two smooth surfaces may be bonded together. Thus, the step of bonding the materials together is much simpler than if the first material 100 had been machined to a complex shape first. The outer surface 210 closely fits the internal surface 110 so that the two surfaces 110, 210 may be bonded together. For example, the bonding may comprise heating the two materials 100, 200 when in contact, i.e. fusion bonding.

Alternatively, the second material 200 may be provided by deposition onto the internal surface 110 so that the two materials meet, and are adjoined, at surfaces 110 and 210. For example, the second material 200 may be sprayed onto the inner surface 110 of the first material 100.

As a further alternative, the second material 200 may be coextruded with the first material 100 to form an intermediate 10 having two materials bonded at the surfaces 110 and 210. For example, the first and second materials 100, 200 may be melted and forced through a die (e.g., a die arranged to form two concentric annular extrusions) which will extrude the materials in the desired form, which is retained on cooling.

As a further alternative, the second material 200 may be glued to the first material 100 to form an intermediate 10 having two materials bonded at the surfaces 110 and 210.

As a further alternative, the second material 200 may be moulded with the first material 100 to form an intermediate 10 having two materials bonded at the surfaces 110 and 210. The moulding preferably comprises one or more of injection moulding, compression moulding and transfer moulding. With an appropriate selection of the crosslinking systems of the first material 100 and the second material 200, the chemical bonding is assured during the moulding process. The use of moulding is particularly preferred in view of low costs.

In each of these options, the first material 100 and second material 200 form layers of the intermediate 10. It can therefore be seen that the invention involves bonding the first and second materials 100, 200 at an early stage of manufacture when it is simpler to do so, thus creating an intermediate 10, and then carrying out a machining operation to produce a more complicated shaped seal 500.

Importantly, the intermediate 10 may form a standardised item of stock that can be used for multiple seals having differing cross-sections. Thus, a large quantity of the intermediate 10 can be produced, leading to production savings, with the only difference in manufacture for each type of seal being the subsequent machining step, which may be a computerised process such as the use of a computer-controlled lathe, such as, for example, an SKF SEALJET machine (e.g. NG025, NG040 or NG060).

FIG. 1 shows a cross-section through an intermediate 10 comprising the first material 100 bonded to the second material 200. A desired cross-sectional shape 400 of a seal 500 is depicted in the cross-section of the intermediate 10.

The intermediate 10 can be subsequently machined to remove the material outside the desired cross-sectional shape 400 to produce a seal 500, such as that shown in FIG. 2.

As can be seen in FIG. 1, the cross-sectional shape 400 encompasses both first and second materials 100, 200, which both form part of the seal 500 (see FIG. 2) resulting from the machining step. As noted above, suitable machining techniques involve cutting the component with a lathe to produce an annular seal with a desired cross-section.

In this embodiment, as shown in FIG. 2, the seal 500 is machined to provide a profile that is generally U-shaped and is defined by a radially extending wall 1, an outer flange wall 2 extending axially from the radial wall 1, and an inner flange wall 3 facing the outer wall and extending generally axially from the radial wall. A seal lip 4 is provided on the radially inner surface of the inner flange wall 3. It can be seen, therefore, that walls 1, 2 and 3 are formed from the first material 100, whereas seal lip 4 is formed from the second material 200. The seal lip 4 is bonded to the inner flange wall 3.

By the provision of the second material 200 having a low coefficient of friction on a radially inner surface 110 of the first material 100 to form an intermediate 10, and then subsequently machining the intermediate 10 to form a seal 500, a seal 500 can be provided that exhibits reduced friction when in sliding contact with a counterface. The counterface may be a rotary shaft of a machine, whereby the outer flange wall 3 of the seal is mounted to e.g. a bore of a housing. The seal may also be executed as a bearing seal that is mounted in the annular gap between the inner and outer rings of the bearing.

As discussed above, instead of just having a low coefficient of friction, the second material 200 may additionally or alternatively exhibit one or more of higher heat resistance, higher wear resistance and/or higher chemical resistance than the first material 100.

With reference to FIGS. 3 and 4, a second embodiment of a method of manufacturing a seal 600 in accordance with the invention comprises the steps of providing an intermediate 20 by providing a first material 100, bonding a second material 200 to the first material 100, and bonding a third material 300 to the first material 100. The second and third materials 200, 300 are different materials from the first material 100. Preferably, the third material 300 is different from the second material 200.

There are many similarities between the first and second embodiments. Accordingly, as with the first embodiment, the third material 300 may be bonded to the first material 100 by: separately forming articles of the materials 100, 300 and bonding these together, for example by gluing or fusion bonding; deposition of the third material 300 onto an article of the first material 100; or co-extrusion of the first and third materials 100, 300 (or the first, second and third materials 100, 200, 300).

Most preferably, as can be seen in FIG. 3, a radially inner surface 320 of the third material 300 is bonded to a radially outer surface 120 of the first material 100, wherein the surface 120 is opposite to the surface 110. That is, the second and third materials 200, 300 may be bonded to opposing surfaces of the first material 100.

As can be seen in FIG. 3, the cross-sectional shape 400 in this embodiment encompasses first, second and third materials 100, 200, 300, which all form part of the seal 600 resulting from the machining step. In this embodiment, as shown in FIG. 4, the seal 600 is machined to provide a profile that is similar to that of the seal 500 of the first embodiment (see FIG. 2), as described above. In particular, the seal 600 is machined to provide a profile that is generally U-shaped and is defined by a radially extending wall 1, an outer flange wall 2 extending axially from the radial wall 1, and an inner flange wall 3 facing the outer wall and extending generally axially from the radial wall. A seal lip 4 is provided on the radially inner surface of the inner flange wall 3. It can be seen, therefore, that walls 1 and 3 are formed from the first material 100, the outer flange wall 2 is formed from the third material 300, and the seal lip 4 is formed from the second material 200. The seal lip 4 is bonded to the inner flange wall 3. Walls 1 and 3 are integrally formed of the same material, while the outer flange wall 2 is bonded to the radial wall 1.

The discussion above in relation to the first 100 and second 200 materials in the first embodiment applies equally to the second embodiment.

By the provision of the third material 300 having high rigidity on a surface of the first material 100 to form an intermediate 10, and then subsequently machining the intermediate 10 to form a seal 500, a seal 500 can be provided with improved rigidity. The improved rigidity may help the seal 500 to maintain its shape in use.

Whilst the second material 200 in the first embodiment and third material 300 in the second embodiment are described with specific properties, these may be interchangeable as required for the particular application.

Furthermore, it is envisaged that the intermediate may comprise further layers on the second and/or third materials 200, 300 without contacting the first material 100.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A method of manufacturing an annular seal comprising the steps of:
(i) providing an intermediate having an annular layer of an elastomeric first material (100) bonded to an annular layer of a second material, the second material being different from the first material; and
(ii) machining the intermediate to form the annular seal comprising the first and second materials, wherein:
the intermediate is machined to provide a profile that is generally U-shaped and is defined by a radially extending wall, an outer flange wall extending axially from the radial wall, and an inner flange wall facing the outer flange wall and extending axially from the radial wall; and
the annular seal has a seal lip that extends radially inward from the inner flange wall, the seal lip formed from the second material and the second material has one or more of: a lower coefficient of friction, a higher heat resistance, a higher wear resistance and/or a higher chemical resistance than the first material.

2. The method of claim 1, wherein the elastomeric first material comprises one or more of fluoroelastomer (FKM), perfluoroelastomer (FFKM), nitrile butadiene rubber (NBR), hydrogenated nitrile butadiene rubber (HNBR), carboxylated nitrile butadiene rubber (XNBR), silicone (VMQ), polyurethane (PU), neoprene (chloroprene), ethylene-propylene-diene (EPDM), ethylene-propylene (EPM), styrene-butadiene (SBR), isobutene-isoprene, thermoplastic polyurethane (TPU) and thermoplastic elastomers (TPE).

3. The method of claim 3, wherein the further material comprises a polymer and one or more of graphite, PTFE, MoS2, nano-fillers, fullerene-like fillers and waxes.

4. The method of claim 1, wherein the further material comprises a polymer and a filler.

5. The method of claim 1, wherein:
step (i) further comprises bonding an annular layer of a third material to the annular layer of the first material, the third material being different from the first material, wherein the annular layers of the second and third materials are bonded to radially opposite sides of the annular layer of the first material.

6. The method of claim 5, wherein the third material has a greater stiffness than the first material.

7. The method of claim 5, wherein the third material comprises a polymer and a filler.

8. The method of claim 5, wherein the radially extending wall of the annular seal is formed from the first material and the outer flange wall is formed from the third material.

9. The method of claim 1, wherein the second material and/or, if present, the third material, is/are bonded to the first material by one or more of co-extrusion, gluing, fusion bonding and moulding.

10. (canceled)

11. (canceled)

12. (canceled)
